(19) United States
(12) Patent Application Publication
(10) Pub. No.: US 2026/0362566 A1
(43) Pub. Date: Nov. 12, 2026

(54) BACKLIGHT DRIVER OF DISPLAY DEVICE

(71) Applicant: ANPEC ELECTRONICS CORPORATION, HSINCHU (TW)

(72) Inventor: WEN-YEN CHEN, Hsinchu City (TW)

(21) Appl. No.: 19/308,333

(22) Filed: Aug. 25, 2025

(30) Foreign Application Priority Data
May 7, 2025 (TW) 114117065

(51) Int. Cl. H05B 45/46; H05B 45/14

(52) U.S. Cl. CPC H05B 45/46; H05B 45/14

(57) ABSTRACT

A backlight driver of a display device includes a power supply circuit, a processor circuit, a light driving circuit and an abnormality detecting circuit. The processor circuit controls the power supply circuit to supply input power to a light-emitting diode string, and outputs a driving pulse width modulation signal and a detection pulse width modulation signal. When the driving pulse width modulation signal reaches a specific driving level, the light driving circuit drives the light-emitting diode string. When the detection pulse width modulation signal reaches a specific detection level, the abnormality detecting circuit detects an output voltage of the light-emitting diode string and determines whether the output voltage of the light-emitting diode string is lower than an abnormality threshold voltage to generate an abnormality detected signal. The processor circuit determines whether an abnormal event occurs in the light-emitting diode string according to the abnormality detected signal.

### CROSS-REFERENCE TO RELATED PATENT APPLICATION

This application claims the benefit of priority to Taiwan Patent Application No. 114117065, filed on May 7, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### Field of the Disclosure

The present disclosure relates to a display device, and more particularly to a backlight driver of a display device.

### Background of the Invention

Display devices, such as liquid crystal display devices (LCD), are widely used in daily life. Since liquid crystal is unable to emit light, backlight sources are configured to supply light having sufficient and evenly distributed brightness so that the liquid crystal display devices are able to display images normally. In recent years, in order to make brightness of screens of the liquid crystal display devices more uniform, to reduce power consumption of the liquid crystal display devices, and to make appearance of the liquid crystal display devices thinner and more stylish, light-emitting diodes (LEDs) are used as the backlight sources for the liquid crystal display devices.

However, abnormal conditions such as open circuit or short circuit may occur in the light-emitting diodes of the backlight sources of the liquid crystal display devices, by which display effects of the liquid crystal display devices are affected. Conventional drivers of the display devices must include additional pins used for detection of abnormal states of the light-emitting diodes.

### SUMMARY OF THE DISCLOSURE

In response to the above-referenced technical inadequacies, the present disclosure provides a backlight driver of a display device. The backlight driver includes a power supply circuit, a processor circuit. a light driving circuit and an abnormality detecting circuit. The power supply circuit is connected to an input terminal of a light-emitting diode string. The processor circuit is connected to the power supply circuit. The processor circuit is configured to control the power supply circuit to supply input power to the light-emitting diode string, and output a driving pulse width modulation signal and a detection pulse width modulation signal. The light driving circuit is connected to the processor circuit and an output terminal of the light-emitting diode string. The light driving circuit is configured to drive the light-emitting diode string when the driving pulse width modulation signal reaches a specific driving level. The abnormality detecting circuit is connected to the light-emitting diode string and the processor circuit. When the detection pulse width modulation signal reaches a specific detection level, the abnormality detecting circuit is configured to detect an output voltage of the output terminal of the light-emitting diode string and determine whether the output voltage is lower than an abnormality threshold voltage to generate an abnormality detected signal. The processor circuit is configured to determine whether an abnormal event occurs in the light-emitting diode string according to the abnormal detected signal.

In order to solve the above-mentioned problems, one of the technical aspects adopted by the present disclosure is to provide a backlight driver of a display device. The backlight driver includes a power supply circuit, a processor circuit, a light driving circuit and an abnormality detecting circuit. The power supply circuit is connected to an input terminal of each of a plurality of light-emitting diode strings. The processor circuit is connected to the power supply circuit. The processor circuit is configured to control the power supply circuit to supply input power to each of the plurality of light-emitting diode strings. The processor circuit is configured to output a plurality of driving pulse width modulation signals that respectively correspond to the plurality of light-emitting diode strings, and output a plurality of detection pulse width modulation signals that respectively correspond to the plurality of light-emitting diode strings. The light driving circuit is connected to the processor circuit and an output terminal of each of the plurality of light-emitting diode strings. When any one of the plurality of driving pulse width modulation signals reaches a specific driving level, the light driving circuit is configured to drive one of the plurality of light-emitting diode strings that corresponds to the one of the plurality of driving pulse width modulation signals. The abnormality detecting circuit is connected to the light driving circuit and the plurality of light-emitting diode strings. When any one of the plurality of detection pulse width modulation signals reaches a specific detection level, the abnormality detecting circuit is configured to detect an output voltage of the output terminal of one of the plurality of light-emitting diode strings that corresponds to the one of the plurality of detection pulse width modulation signals, and determine whether the output voltage is lower than an abnormality threshold voltage, so as to output an abnormality detected signal. The processor circuit is configured to determine whether the abnormal event occurs in the plurality of light-emitting diode strings according to the abnormality detected signal.

As described above, the present disclosure provides the backlight driver of the display device. The backlight driver of the display device of the present disclosure is capable of accurately determining whether the abnormal state of the detected light-emitting diode strings, in particular, determining whether the abnormal events such as an open circuit and a short circuit occur, without disposing additional pins. In comparison with a conventional backlight driver that must include additional pins used for detection of abnormal states, circuit cost of the backlight driver of the display device of the present disclosure is reduced.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a circuit diagram of a backlight driver of a display device according to a first embodiment of the present disclosure;

FIG. 2 is a flowchart diagram of a backlight driver of a display device according to a second embodiment of the present disclosure;

FIG. 3 is a circuit diagram of a backlight driver of a display device according to a third embodiment of the present disclosure;

FIG. 4 is a circuit diagram of a backlight driver of a display device according to a fourth embodiment of the present disclosure;

FIG. 5 is a circuit diagram of a backlight driver of a display device according to a fifth embodiment of the present disclosure;

FIG. 6 is a circuit diagram of a backlight driver of a display device according to a sixth embodiment of the present disclosure; and

FIG. 7 is a circuit diagram of a backlight driver of a display device according to a seventh embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

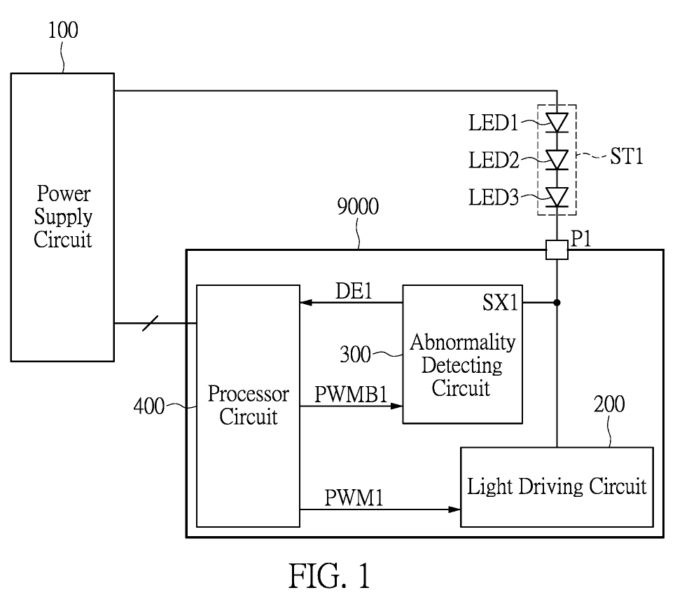

Reference is made to FIG. 1, which is a circuit diagram of a backlight driver of a display device according to a first embodiment of the present disclosure.

The backlight driver of the display device of the present disclosure is applicable to drive a backlight source and detect an abnormal state of the backlight source. The backlight source includes at least one light-emitting diode strings such as, but not limited to, a light-emitting diode string ST1 shown in FIG. 1. The light-emitting diode string ST1 may include a plurality of light-emitting diodes such as, but not limited to, three light-emitting diodes LED1 to LED3 shown in FIG. 1. It should be understood that, the number of the light-emitting diodes included in the light-emitting diode string ST1 depends on actual requirements. The light-emitting diode string ST1 described herein may be replaced with one light-emitting diode.

As shown in FIG. 1, the backlight driver of the display device of the present disclosure includes a power supply circuit 100 and a backlight detection driving circuit 9000. The backlight detection driving circuit 9000 includes a light driving circuit 200, an abnormality detecting circuit 300 and a processor circuit 400.

In the light-emitting diode string ST1, the plurality of light-emitting diodes LED1 to LED3 are sequentially arranged and connected with each other in parallel. An anode of the light-emitting diode LED2 arranged next to the light-emitting diode LED1 is connected to a cathode of the light-emitting diode LED1, and an anode of the light-emitting diode LED3 arranged next to the light-emitting diode LED2 is connected to a cathode of the light-emitting diode LED2.

A power supply indication terminal of the processing circuit 400 is connected to a processing indication terminal of the power supply circuit 100. A power supply terminal of the power supply circuit 100 is connected to the anode of the light-emitting diode LED1 that is a first one of the plurality of light-emitting diodes LED1 to LED3 and used as an input terminal of the light-emitting diode string ST1.

A cathode of the light-emitting diode LED3 that is a latest one of the plurality of light-emitting diodes LED1 to LED3 is used as an output terminal of the light-emitting diode string ST1. The cathode of the light-emitting diode LED3 is connected to a detection input terminal SX1 of the abnormality detecting circuit 300 and a lighting driving terminal of the light driving circuit 200 through only a pin P1 of the backlight detection driving circuit 9000. The pin P1 described herein is a pin originally included in the backlight detection driving circuit 9000 of the backlight driver of the display device of the present disclosure.

A detection output terminal of the abnormality detecting circuit 300 is connected to a detection receiving terminal of the processor circuit 400. A detection clock terminal of the processor circuit 400 is connected to a clock receiving terminal of the abnormality detecting circuit 300. A driving clock terminal of the processor circuit 400 is connected to a clock receiving terminal of the light driving circuit 200.

The processor circuit 400 generates a power supply instruction signal. The power supply instruction signal is supplied through a supply instruction terminal of the processor circuit 400 to the processing indication terminal of the power supply circuit 100 for controlling the power supply circuit 100 to supply input power to the light-emitting diode string ST1. The input power described herein includes an input voltage, an input current or a combination thereof.

When the power supply circuit 100 supplies the input power to the light-emitting diode string ST1, the processor circuit 400 generates a driving pulse width modulation signal PWM1 including a plurality of pulse waves. The driving clock terminal of the processor circuit 400 outputs the driving pulse width modulation signal PWM1 to the clock receiving terminal of the light driving circuit 200.

The light driving circuit 200 sets a frequency of each of the plurality of pulse waves of the driving pulse width modulation signal PWM1 as a driving frequency of the light-emitting diode string ST1, and drives the light-emitting diode string ST1 to emit light based on the driving frequency.

When the driving pulse width modulation signal PWM1 received by the light driving circuit 200 reaches a specific driving level (that is a first level, such as a high level), the light driving circuit 200 drives the light-emitting diode string ST1 to emit light. In other words, the light driving circuit 200 drives the light-emitting diode string ST1 within a working period of each of the plurality of pulse waves of the driving pulse width modulation signal PWM1.

Conversely, when the driving pulse width modulation signal PWM1 received by the light driving circuit 200 does not reach the specific driving level (that is an initial level, such as a low level), the light driving circuit 200 does not drive the light-emitting diode string ST1.

In addition, the processor circuit 400 generates a detection pulse width modulation signal PWMB1 including a plurality of pulse waves. The detection clock terminal of the processor circuit 400 outputs the detection pulse width modulation signal PWMB1 to the detection output terminal of the abnormality detecting circuit 300.

As described herein, the detection pulse width modulation signal PWMB1 is used for detection of the light-emitting diode string ST1, but the driving pulse width modulation signal PWM1 is used for driving of the light-emitting diode string ST1. A plurality of levels of the detection pulse width modulation signal PWMB1 described herein may be opposite to that of the driving pulse width modulation signal PWM1, respectively. The levels described herein are voltage levels or logic levels.

That is, when the detection pulse width modulation signal PWMB1 reaches the first level (such as the high level), the driving pulse width modulation signal PWM1 reaches the initial level (such as the low level). Conversely, when the detection pulse width modulation signal PWMB1 reaches the initial level (such as the low level), the driving pulse width modulation signal PWM1 reaches the first level (such as the high level).

When the detection pulse width modulation signal PWMB1 reaches the specific detection level (that is the first level, such as the high level), the abnormality detecting circuit 300 detects an output voltage of the output terminal of the light-emitting diode string ST1 that is received by the detection input terminal SX1 of the abnormality detecting circuit 300 and determines whether or not the output voltage is lower than an abnormality threshold voltage TH to output an abnormality detected signal DE1.

The output voltage of the output terminal of the light-emitting diode string ST1 is a voltage of the cathode of the light-emitting diode LED3 that is the latest one of the plurality of light-emitting diodes LED1 to LED3 of the light-emitting diode string ST1.

After the light-emitting diode string ST1 is driven by the light driving circuit 200, the light-emitting diode string ST1 may fail to emit light normally, which may be caused by an open circuit, a short circuit or other abnormal events that occur between the light-emitting diode string ST1 and the backlight driver of the display device of the present disclosure.

Therefore, the abnormality detecting circuit 300 detects the output voltage of the light-emitting diode string ST1. The power supply circuit 100, according to the output voltage detected by the abnormality detecting circuit 300, determines whether the abnormal event occurs in the light-emitting diode string ST1, and determines whether the abnormal event (such as the open circuit or short circuit) occurs between the light-emitting diode string ST1 and the backlight driver of the display device of the present disclosure, and accordingly outputs the abnormality detected signal DE1.

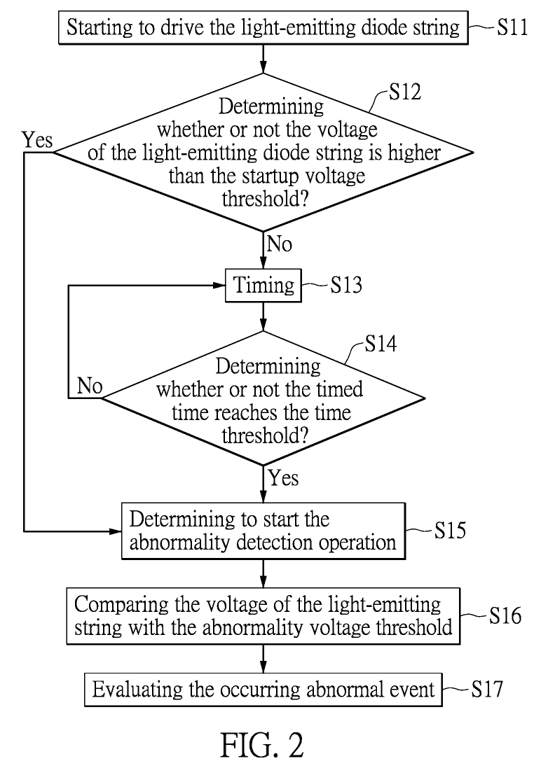

Reference is made to FIG. 2, which is a flowchart diagram of a backlight driver of a display device according to a second embodiment of the present disclosure.

The backlight driver of the display device of the present disclosure as shown in FIGS. 1 or 3-7 is applicable to perform processes S11 to S17 shown in FIG. 2.

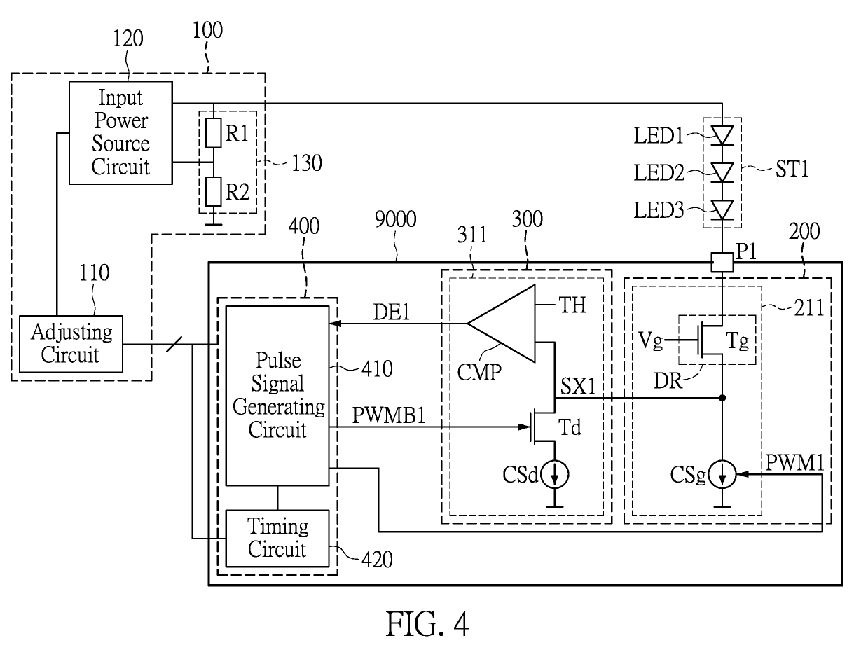

The processor circuit 400 shown in FIG. 1 or a pulse signal generating circuit 410 included in the processor circuit 400 shown in FIGS. 4,5 and 7, outputs the power supply instruction signal to the power supply circuit 100 shown in FIG. 1 or an adjusting circuit 110 included in the power supply circuit 100 shown in FIGS. 4,5 and 7, . The power supply circuit 100 outputs the input power to the light-emitting diode string ST1 according to the power supply instruction signal.

The light driving circuit 200 shown in FIGS. 1-7 to starts driving the light-emitting diode string ST1 based on the driving pulse width modulation signal PWM1 that reaches the specific driving level (that is the first level, such as the high level) from the processor circuit 400 or the pulse signal generating circuit 410 (in process S11 shown in FIG. 2).

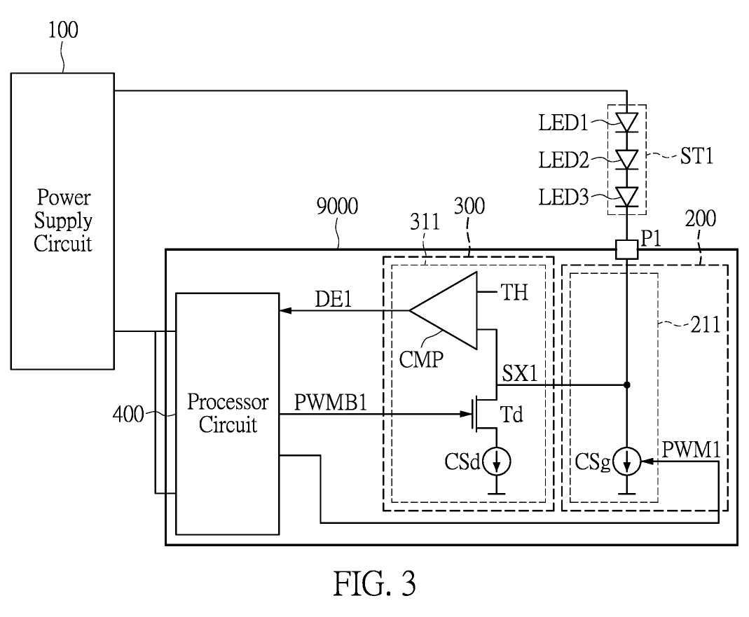

When the input voltage that is supplied to the light-emitting diode string ST1 by the power supply circuit 100 or an input power source circuit 120 included in the power supply circuit 100 shown in FIGS. 3-7 does not reach a voltage value that is sufficient to generate a current flowing through the light-emitting diode string ST1, the open circuit may be incorrectly determined according to voltage messages of the light-emitting diode string ST1. Therefore, the processor circuit 400 or the pulse signal generating circuit 410 determines whether or not the output voltage of the light-emitting diode string ST1 detected by the abnormality detecting circuit 300 is higher than the startup voltage threshold (in process S12 shown in FIG. 2).

If the output voltage of the light-emitting diode string ST1 is not higher than the startup voltage threshold, the processor circuit 400 shown in FIG. 1 or a timing circuit 420 included in the processor circuit 400 shown in FIGS. 4,5 and 7, times a period of time during which the power supply circuit 100 or the input power source circuit 120 supplies the input power to the light-emitting diode string ST1 and the light driving circuit 200 drives the light-emitting diode string ST1, as a time count value (in process S13 shown in FIG. 2).

The processor circuit 400 or the pulse signal generating circuit 410 determines whether or not the time count value is larger than a time threshold (in process S14 shown in FIG. 2).

When the time count value is not larger than a time threshold, the processor circuit 400 continually times or the pulse signal generating circuit 410 instructs the timing circuit 420 to continually time. Further, when the time count value reaches the time threshold, the processor circuit 400 or the pulse signal generating circuit 410 determines to start an abnormality detection operation (in process S15 shown in FIG. 2), and outputs the detection pulse width modulation signal PWMB1 that reaches the specific detection level to the abnormality detecting circuit 300.

If the output voltage of the light-emitting is higher than the startup voltage threshold such as, but not limited to, 0.2V (in process S12 shown in FIG. 2), the processor circuit 400 or the pulse signal generating circuit 410 determines to start the abnormality detection operation (in process S15 shown in FIG. 2), and outputs the detection pulse width modulation signal PWMB1 that reaches the specific detection level (that is the first level, such as the high level) to the abnormality detecting circuit 300.

Then, the abnormality detecting circuit 300, based on the detection pulse width modulation signal PWMB1 that reaches the specific detection level, detects the output voltage of the light-emitting diode string ST1 and compares the output voltage of the light-emitting diode string ST1 with the abnormality threshold voltage TH (in process S16 shown in FIG. 2). The abnormality detecting circuit 300 determines whether the output voltage of the light-emitting diode string ST1 is lower than the abnormality threshold voltage TH to determine whether or not the abnormal event occurs in the light-emitting diode string ST1(in process S17 shown in FIG. 2).

When the output voltage of the light-emitting diode string ST1 is not lower than the abnormality threshold voltage TH, the abnormality detecting circuit 300 determines that the abnormal event does not occur in the light-emitting diode string ST1.

However, when the output voltage of the light-emitting diode string ST1 is lower than the abnormality threshold voltage TH, the abnormality detecting circuit 300 determines that the abnormal event occurs in the light-emitting diode string ST1. For example, an open circuit event occurs between the light-emitting diode string ST1 and the backlight driver of the display device of the present disclosure, or a short circuit occurs between the pin P1 connected to the light-emitting diode string and a ground.

Reference is made to FIG. 3, which is a circuit diagram of a backlight driver of a display device according to a third embodiment of the present disclosure.

The descriptions of the third embodiment of the present disclosure that are the same as the descriptions of the first embodiment of the present disclosure are not repeated herein.

As shown in FIG. 3, in the third embodiment, the backlight driver of the display device of the present disclosure only drives the light-emitting string ST1, and thus the light driving circuit 200 only includes one single-point driving circuit 211 and the abnormality detecting circuit 300 only includes one single-point detecting circuit 311.

For example, as shown in FIG. 3, the single-point driving circuit 211 includes a driving current source CSg. A control terminal of the driving current source CSg is connected to the driving clock terminal of the processor circuit 400. A first terminal of the driving current source CSg is connected to output terminals of the plurality of light-emitting diode strings ST1 to STn. A second terminal of the driving current source CSg may be grounded.

For example, as shown in FIG. 3, the single-point detecting circuit 311 includes a comparator CMP, a detection switch Td and a detection current source CSd. In practice, the detection current source CSd may be omitted.

A first input terminal (such as a non-inverting input terminal) of the comparator CMP is coupled to the abnormality threshold voltage TH. A second input terminal (such as an inverting input terminal) of the comparator CMP is used as the detection input terminal SX1 of the abnormality detecting circuit 300, and is connected to the output terminal of the light-emitting string ST1 through only the pin P1 of the backlight detection driving circuit 9000 or is connected to a detection node between the light driving circuit 200 and the output terminal of the light-emitting diode string ST1. An output terminal of the comparator CMP is connected to the detection receiving terminal of the processor circuit 400.

A first terminal of the detection switch Td is connected to the output terminal of the light-emitting diode string ST1, or is connected to the detection node between the light driving circuit 200 and the output terminal of the light-emitting diode string ST1. A second terminal of the detection switch Td is grounded. A control terminal of the detection switch Td is used as the clock receiving terminal of the abnormality detecting circuit 300, and is connected to the detection clock terminal of the processor circuit 400.

When the driving pulse width modulation signal PWM1 received by the control terminal of the driving current source CSg reaches the specific driving level (that is the first level, such as the high level), the driving current source CSg supplies a driving current to the light-emitting string ST1 for driving the light-emitting string ST1.

Then, when the driving pulse width modulation signal PWM1 received by the control terminal of the driving current source CSg reaches a non-specified driving level (that is the initial level, such as the low level), the driving current source CSg does not supply the driving current. At this time, the light-emitting string ST1 is not driven.

When the detection pulse width modulation signal PWMB1 that is received from the detection clock terminal of the processing circuit 400 by the control terminal of the detection switch Td reaches the specific driving level (that is the first level, such as the high level), the detection current source CSd supplies a detection current (having a constant current value), and at least parts of an output current of the light-emitting string ST1 flows to the detection switch Td.

The comparator CMP compares a voltage of the second input terminal (such as the inverting input terminal) of the comparator CMP with the abnormality threshold voltage TH of the first input terminal (such as the non-inverting input terminal) of the comparator CMP to output the abnormality detected signal DE1.

The processor circuit 400 may, according to the abnormality detected signal DE1 from the comparator CMP, determine whether the abnormal event occurs in the light-emitting string ST1, for example, determine whether the open circuit event occurs between the light-emitting diode string ST1 and the backlight detection driving circuit 9000 of the present disclosure, or the short circuit occurs between the pin P1 and the ground. When the abnormal events such as the open circuit and the short circuit occur as described above, no current or insufficient current flows through the light-emitting string ST1, such that the backlight driver of the display device of the present disclosure is unable to smoothly drive the LED light-emitting string ST1 to emit light in a desired state.

Reference is made to FIG. 4, which is a circuit diagram of a backlight driver of a display device according to a fourth embodiment of the present disclosure.

The descriptions of the fourth embodiment of the present disclosure that are the same as the descriptions of the first to third embodiments of the present disclosure are not repeated herein.

As shown in FIG. 4, in the fourth embodiment, the single-point driving circuit 211 of the backlight driver of the display device of the present disclosure not only includes the driving current source CSg, but further includes a voltage drop receiving circuit DR. The processor circuit 400 includes the pulse signal generating circuit 410 and the input power source circuit 120. In practice, the processor circuit 400 shown in FIGS. 1,3 and 6, may be replaced with that shown in FIG. 4.

In order to prevent the driving current source CSg from receiving an excessively high voltage drop and being burned by the excessively high voltage drop, the voltage drop receiving circuit DR is connected between the output terminal of the light-emitting diode string ST1 (that is the cathode of the light-emitting diode LED3) and the driving current source CSg, and configured to receive a voltage drop between the output terminal of the light-emitting diode string ST1 and the driving current source CSg.

For example, the voltage drop receiving circuit DR includes a transistor as a voltage drop receiving transistor Tg. A first terminal of the voltage drop receiving transistor Tg is connected to the output terminal of the light-emitting string ST1. A second terminal of the voltage drop receiving transistor Tg is connected to the driving current source CSg. A control terminal of the voltage drop receiving transistor Tg is coupled to a control voltage Vg. A control terminal of the voltage drop receiving transistor Tg may receive the control voltage Vg maintained at the first level (such as the high level) such that the voltage drop receiving transistor Tg is turned on continually.

As shown in FIG. 4, in the fourth embodiment, the power supply circuit 100 includes the adjusting circuit 110 and the input power source circuit 120. In practice, the power supply circuit 100 shown in FIGS. 1,3 and 6, may be replaced with that shown in FIG. 4.

The adjusting circuit 110 is connected to the pulse signal generating circuit 410. The adjusting circuit 110 sets a specific input power amount according to a power supply indication signal from the pulse signal generating circuit 410.

The input power source circuit 120 is connected to the adjusting circuit 110 and the light-emitting string ST1. The input power source circuit 120, according to the specific input power amount from the adjusting circuit 110, outputs the specific input power amount of the input power (such as the input voltage or the input current) to the light-emitting string ST1.

If necessary, the power supply circuit 100 may further include a voltage divider circuit 130. An input terminal of the voltage divider circuit 130 is connected to an output terminal of the input power source circuit 120. An output terminal of the voltage divider circuit 130 is connected to a feedback input terminal of the input power source circuit 120. The voltage divider circuit 130 is configured to feedback the input voltage that is supplied to the light-emitting string ST1 from the output terminal of the input power source circuit 120 to the feedback input terminal of the input power source circuit 120.

For example, the voltage divider circuit 130 includes a first voltage dividing resistor R1 and a second voltage dividing resistor R2. A first terminal of the first voltage dividing resistor R1 is connected to the output terminal of the input power source circuit 120. A first terminal of the second voltage dividing resistor R2 is connected to a second terminal of the first voltage dividing resistor R1. A second terminal of the second voltage dividing resistor R2 is grounded. A feedback node between the first terminal of the second voltage dividing resistor R2 and the second terminal of the first voltage dividing resistor R1 is connected to the feedback input terminal of the input power source circuit 120.

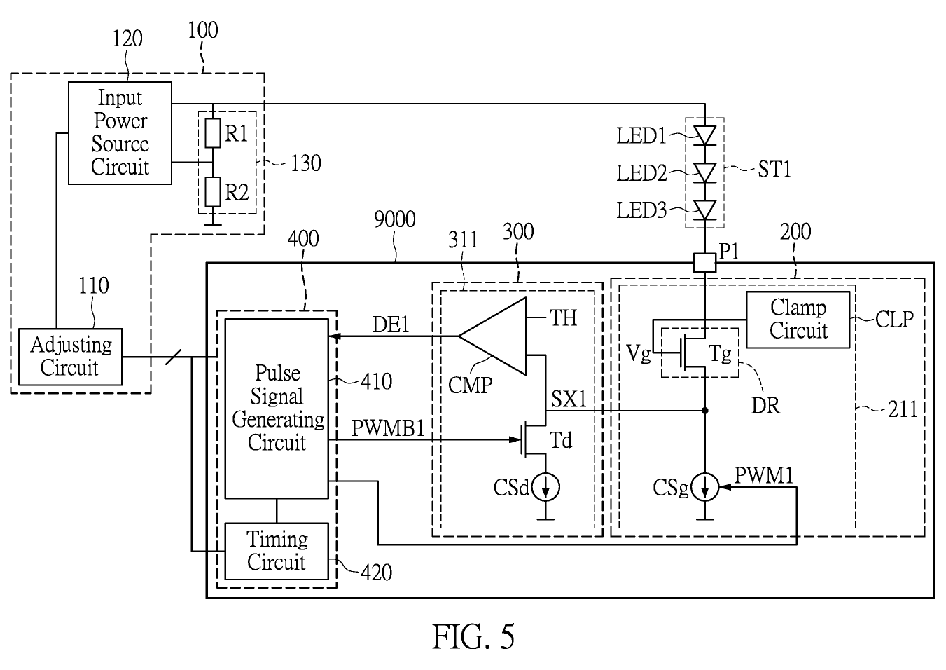

Reference is made to FIG. 5, which is a circuit diagram of a backlight driver of a display device according to a fifth embodiment of the present disclosure.

The descriptions of the fifth embodiment of the present disclosure that are the same as the descriptions of the first to fourth embodiments of the present disclosure are not repeated herein.

As shown in FIG. 5, in the fifth embodiment, the single-point driving circuit 211 of the backlight driver of the display device of the present disclosure not only includes the driving current source CSg and the voltage drop receiving circuit DR, but further includes a clamp circuit CLP.

The clamp circuit CLP is connected to the control terminal of the voltage drop receiving transistor Tg.

The clamp circuit CLP clamps a voltage of the control terminal of the voltage drop receiving transistor Tg to be equal to the control voltage Vg having a constant voltage value, so that the voltage drop receiving transistor Tg is maintained stably in an on-state. Therefore, an overall operation of the backlight driver of the display device of the present disclosure is stable.

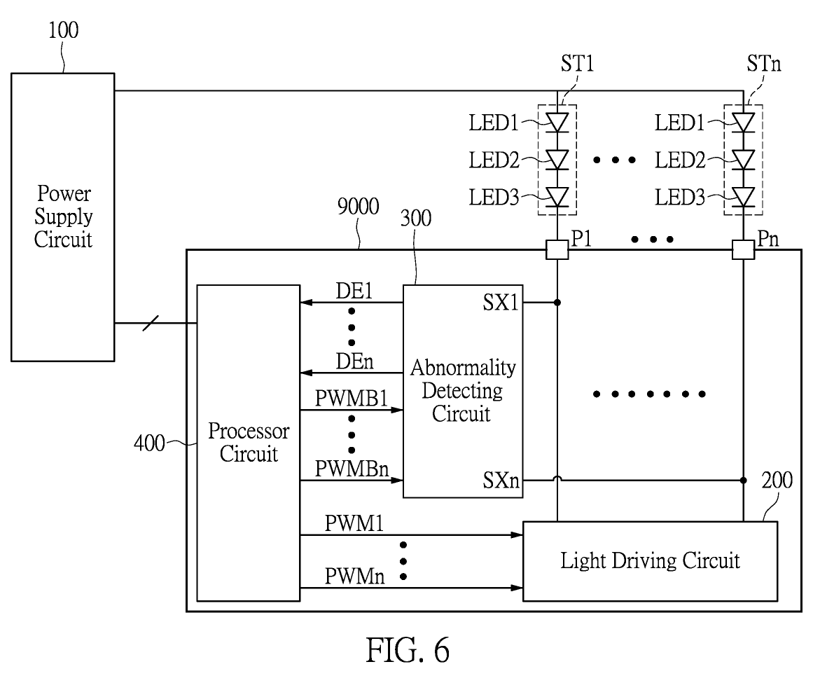

Reference is made to FIG. 6, which is a circuit diagram of a backlight driver of a display device according to a sixth embodiment of the present disclosure.

The descriptions of the sixth embodiment of the present disclosure that are the same as the descriptions of the first embodiment of the present disclosure are not repeated herein. A difference between the sixth and first embodiments of the present disclosure is that, the backlight driver of the display device of the first embodiment of the present disclosure as shown in FIG. 1 is used for driving only the light-emitting string ST1, but the backlight driver of the display device of the sixth embodiment of the present disclosure as shown in FIG. 6 is used for driving the plurality of light-emitting diode strings ST1 to STn.

As shown in FIG. 6, the power supply circuit 100 is connected to an input terminal of each of the plurality of light-emitting diode strings ST1 to STn, and configured to output the input power (such as the input voltage or the input current) to the input terminal of each of the plurality of light-emitting diode strings ST1 to STn.

Output terminals of the plurality of light-emitting diode strings ST1 to STn are, through a plurality of pints P1 to Pn of the backlight detection driving circuit 9000, respectively connected to a plurality of detection input terminals SX1 to SXn of the abnormality detecting circuit 300, and respectively connected to a plurality of light driving terminals of the light driving circuit 200. The pins P1 to Pn described herein are pins originally included in the backlight detection driving circuit 9000 of the present disclosure.

The processor circuit 400 outputs the plurality of driving pulse width modulation signals PWM1 to PWMn that respectively correspond to the plurality of light-emitting diode strings ST1 to STn to the light driving circuit 200, and outputs a plurality of detection pulse width modulation signals PWMB1 to PWMBn that respectively correspond to the plurality of light-emitting diode strings ST1 to STn to the abnormality detecting circuit 300.

When any one of the plurality of driving pulse width modulation signals PWM1 to PWMn reaches the specific driving level (that is the first level, such as the high level), the light driving circuit 200 drives one of the plurality of light-emitting diode strings ST1 to STn that corresponds to the one of the plurality of driving pulse width modulation signals PWM1 to PWMn to emit light.

When any one of the plurality of detection pulse width modulation signals PWMB1 to PWMBn reaches the specific detection level (that is the first level, such as the high level), the abnormality detecting circuit 300 detects the output voltage of one of the plurality of light-emitting diode strings ST1 to STn that corresponds to the one of the plurality of detection pulse width modulation signals PWMB1 to PWMBn, and determines whether the output voltage of the one the plurality of light-emitting diode strings ST1 to STn is lower than the abnormality threshold voltage TH, to generate a detection result. The abnormality detecting circuit 300 outputs a plurality of abnormality detected signals DE1 to DEn respectively according to the detection results of the plurality of light-emitting diode strings ST1 to STn.

The processor circuit 400 determines whether the abnormal event occurs in the plurality of light-emitting diode strings ST1 to STn according to the plurality of abnormality detected signals DE1 to DEn.

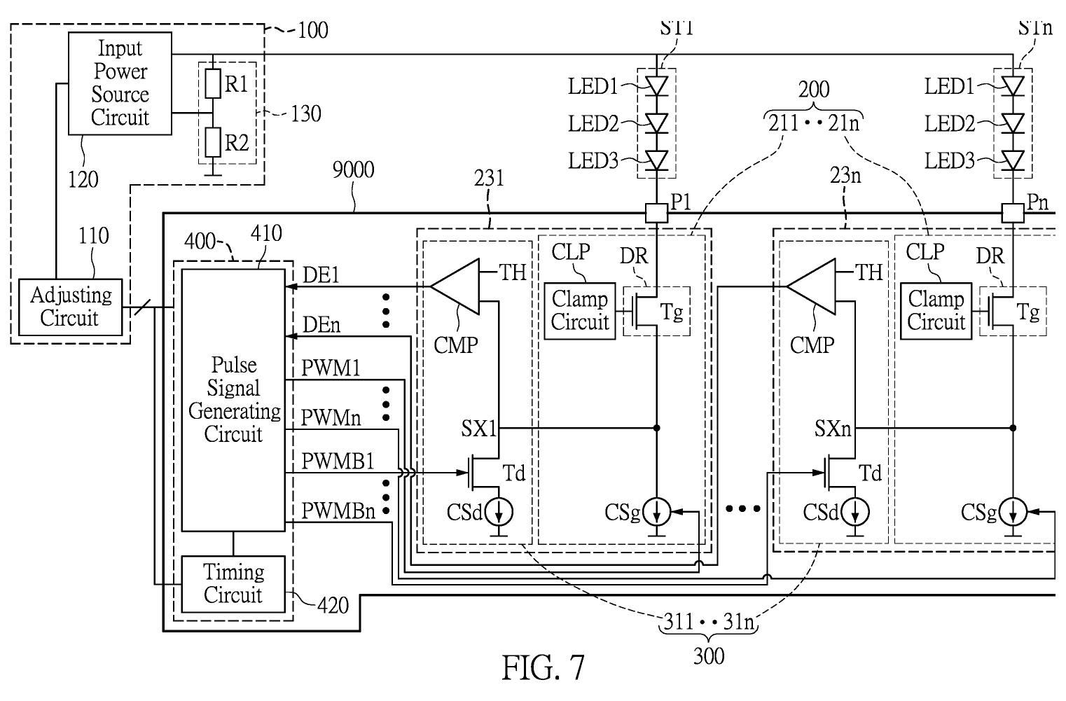

Reference is made to FIG. 7, which is a circuit diagram of a backlight driver of a display device according to a seventh embodiment of the present disclosure.

As shown in FIG. 7, the backlight driver of the display device of the present disclosure includes the power supply circuit 100 and the backlight detection driving circuit 9000, and the backlight detection driving circuit 9000 includes the light driving circuit 200, the abnormality detecting circuit 300 and the processor circuit 400.

The light driving circuit 200 includes a plurality of single-point driving circuits 211 to 21n that are respectively used for driving the plurality of light-emitting diode strings ST1 to STn, and the abnormality detecting circuit 300 includes a plurality of single-point detecting circuits 311 to 31n that are respectively used for detecting the plurality of light-emitting diode strings ST1 to STn.

In other words, the backlight detection driving circuit 9000 of the backlight driver of the display device of the present disclosure includes a plurality of light driving detector circuits 231 to 23n that are respectively used on the plurality of light-emitting diode strings ST1 to STn. The plurality of light driving detector circuits 231 to 23n respectively include the plurality of single-point driving circuits 211 to 21n, and respectively include the plurality of single-point detecting circuits 311 to 31n.

The configurations inside the single-point driving circuit 211 and the single-point detecting circuit 311 are described above. The single-point driving circuits 211 to 21n are the same with each other and the plurality of single-point detecting circuits 311 to 31n are the same with each other, the descriptions of which are not repeated herein.

It should be understood that, the number of the light-emitting diode strings ST1 to STn depends on actual requirements, and the number of the single-point driving circuits 211 to 21n and the number of the single-point detecting circuits 311 to 31n depend on the number of the light-emitting diode strings ST1 to STn.

In conclusion, the present disclosure provides the backlight driver of the display device. The backlight driver of the display device of the present disclosure is capable of accurately determining whether the abnormal state of the detected light-emitting diode strings, in particular, determining whether the abnormal events such as the open circuit and the short circuit occur, without disposing additional pins. In comparison with a conventional backlight driver that must include additional pins used for detection of abnormal states, circuit cost of the backlight driver of the display device of the present disclosure is reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A backlight driver of a display device, comprising:
a power supply circuit connected to an input terminal of a light-emitting diode string;
a processor circuit connected to the power supply circuit, wherein the processor circuit is configured to control the power supply circuit to supply input power to the light-emitting diode string, and output a driving pulse width modulation signal and a detection pulse width modulation signal;
a light driving circuit connected to the processor circuit and an output terminal of the light-emitting diode string, wherein the light driving circuit is configured to drive the light-emitting diode string when the driving pulse width modulation signal reaches a specific driving level; and
an abnormality detecting circuit connected to the light-emitting diode string and the processor circuit, wherein, when the detection pulse width modulation signal reaches a specific detection level, the abnormality detecting circuit is configured to detect an output voltage of the output terminal of the light-emitting diode string and determine whether the output voltage is lower than an abnormality threshold voltage to generate an abnormality detected signal;
wherein the processor circuit is configured to determine whether an abnormal event occurs in the light-emitting diode string according to the abnormal detected signal.

2. The backlight driver of the display device according to claim 1, wherein the abnormality detecting circuit includes:
a comparator, wherein a first input terminal of the comparator is coupled to the abnormality threshold voltage, a second input terminal of the comparator is connected to a detection node between the light driving circuit and the output terminal of the light-emitting diode string, and an output terminal of the comparator is connected to the processor circuit and configured to output the abnormality detected signal; and
a detection switch, wherein a first terminal of the detection switch is connected to the detection node, a second terminal of the detection switch is grounded, and a control terminal of the detection switch is connected to the processor circuit and configured to receive the detection pulse width modulation signal.

3. The backlight driver of the display device according to claim 2, wherein the abnormality detecting circuit includes:
a detection current source connected to the second terminal of the detection switch.

4. The backlight driver of the display device according to claim 1, wherein the light driving circuit includes:
a driving current source, wherein a control terminal of the driving current source is connected to the processor circuit and configured to receive the driving pulse width modulation signal, and a first terminal of the driving current source is connected to the output terminal of the light-emitting diode string.

5. The backlight driver of the display device according to claim 4, wherein the light driving circuit includes:
a voltage drop receiving circuit connected between the light-emitting diode string and the driving current source, and configured to receive a voltage drop between the light-emitting diode string and the driving current source.

6. The backlight driver of the display device according to claim 5, wherein the voltage drop receiving circuit includes:
a voltage drop receiving transistor, wherein a first terminal of the voltage drop receiving transistor is connected to the output terminal of the light-emitting diode string, a second terminal of the voltage drop receiving transistor is connected to the driving current source, and a control terminal of the voltage drop receiving transistor is coupled to a control voltage.

7. The backlight driver of the display device according to claim 6, wherein the light driving circuit further includes:
a clamp circuit connected to the control terminal of the voltage drop receiving transistor and configured to clamp a voltage of the control terminal of the voltage drop receiving transistor to be equal to the control voltage.

8. The backlight driver of the display device according to claim 1, wherein the processor circuit includes:
a pulse signal generating circuit connected to the power supply circuit, the light driving circuit and the abnormality detecting circuit, wherein the pulse signal generating circuit is configured to output the driving pulse width modulation signal, and output the detection pulse width modulation signal having the specific detection level when the abnormality detected signal indicates that the output voltage of the light-emitting diode string is higher than a startup voltage threshold.

9. The backlight driver of the display device according to claim 8, wherein the processor circuit further includes:
a timing circuit connected to the pulse signal generating circuit, wherein the timing circuit is configured to time a period of time during which the output voltage of the light-emitting diode string is not higher than the startup voltage threshold, and instruct the pulse signal generating circuit to output the detection pulse width modulation signal having the specific detection level when the period of time reaches a time threshold.

10. The backlight driver of the display device according to claim 8, wherein the power supply circuit includes:
an adjusting circuit connected to the pulse signal generating circuit, wherein the adjusting circuit is configured to set a specific input power amount according to a power supply indication signal from the pulse signal generating circuit; and
an input power source circuit connected to the adjusting circuit and the light-emitting diode string, and configured to output the input power to the light-emitting diode string according to the specific input power amount.

11. A backlight driver of a display device, comprising:
a power supply circuit connected to an input terminal of each of a plurality of light-emitting diode strings;
a processor circuit connected to the power supply circuit, wherein the processor circuit is configured to control the power supply circuit to supply input power to each of the plurality of light-emitting diode strings, output a plurality of driving pulse width modulation signals that respectively correspond to the plurality of light-emitting diode strings, and output a plurality of detection pulse width modulation signals that respectively correspond to the plurality of light-emitting diode strings;
a light driving circuit connected to the processor circuit and an output terminal of each of the plurality of light-emitting diode strings, wherein, when any one of the plurality of driving pulse width modulation signals reaches a specific driving level, the light driving circuit is configured to drive one of the plurality of light-emitting diode strings that corresponds to the one of the plurality of driving pulse width modulation signals; and
an abnormality detecting circuit connected to the light driving circuit and the plurality of light-emitting diode strings, wherein, when any one of the plurality of detection pulse width modulation signals reaches a specific detection level, the abnormality detecting circuit is configured to detect an output voltage of the output terminal of one of the plurality of light-emitting diode strings that corresponds to the one of the plurality of detection pulse width modulation signals, and configured to determine whether the output voltage is lower than an abnormality threshold voltage, to output an abnormality detected signal;
wherein the processor circuit is configured to determine whether the abnormal event occurs in the plurality of light-emitting diode strings according to the abnormality detected signal.

12. The backlight driver of the display device according to claim 11, wherein the abnormality detecting circuit includes a plurality of single-point detecting circuits that are respectively configured to detect the plurality of the light-emitting diode strings, and the light driving circuit includes a plurality of single-point driving circuits that are respectively configured to drive the plurality of the light-emitting diode strings.

13. The backlight driver of the display device according to claim 12, wherein each of the plurality of the single-point detecting circuits includes:
a comparator, wherein a first input terminal of the comparator is coupled to the abnormality threshold voltage, a second input terminal of the comparator is connected to a detection node between the light driving circuit and the output terminal of the light-emitting diode string, and an output terminal of the comparator is connected to the processor circuit and configured to output the abnormality detected signal; and
a detection switch, wherein a first terminal of the detection switch is connected to the detection node, a second terminal of the detection switch is grounded, and a control terminal of the detection switch is connected to the processor circuit and configured to receive the detection pulse width modulation signal.

14. The backlight driver of the display device according to claim 13, wherein each of the plurality of the single-point detecting circuits further includes:
a detection current source connected to the second terminal of the detection switch.

15. The backlight driver of the display device according to claim 12, wherein each of the plurality of the single-point driving circuits includes:
a driving current source, wherein a control terminal of the driving current source is connected to the processor circuit and configured to receive the driving pulse width modulation signal, and a first terminal of the driving current source is connected to the output terminal of the light-emitting diode string.

16. The backlight driver of the display device according to claim 15, wherein each of the plurality of the single-point driving circuits further includes:
a voltage drop receiving transistor, wherein a first terminal of the voltage drop receiving transistor is connected to the output terminal of the light-emitting diode string, a second terminal of the voltage drop receiving transistor is connected to the driving current source, and a control terminal of the voltage drop receiving transistor is coupled to a control voltage.

17. The backlight driver of the display device according to claim 16, wherein each of the plurality of the single-point driving circuits further includes:
a clamp circuit connected to the control terminal of the voltage drop receiving transistor, and configured to clamp a voltage of the control terminal of the voltage drop receiving transistor to be equal to the control voltage.

18. The backlight driver of the display device according to claim 11, wherein the processor circuit includes:
a pulse signal generating circuit connected to the power supply circuit, the light driving circuit and the abnormality detecting circuit, wherein the pulse signal generating circuit is configured to output the driving pulse width modulation signal, and output the detection pulse width modulation signal having the specific detection level when the abnormality detected signal indicates that the output voltage of the each of the plurality of light-emitting diode strings is higher than a startup voltage threshold.

19. The backlight driver of the display device according to claim 18, wherein the processor circuit further includes:
a timing circuit connected to the pulse signal generating circuit, wherein the timing circuit is configured to time a period of time during which the output voltage of each of the plurality of light-emitting diode strings is not higher than the startup voltage threshold, and configured to instruct the pulse signal generating circuit to output the detection pulse width modulation signal having the specific detection level when the period of time reaches a time threshold.

20. The backlight driver of the display device according to claim 18, wherein the power supply circuit includes:
an adjusting circuit connected to the pulse signal generating circuit, and configured to set a specific input power amount according to a power supply indication signal from the pulse signal generating circuit; and
an input power source circuit connected to the adjusting circuit and each of the plurality of light-emitting diode strings, and configured to output the input power to each of the plurality of light-emitting diode strings according to the specific input power amount.
